(19) United States
(12) Patent Application Publication
(10) Pub. No.: US 2023/0027228 A1
(43) Pub. Date: Jan. 26, 2023

(54) TRUNK BUS SYSTEM

(71) Applicant: Voltage, LLC, Chapel Hill, NC (US)

(72) Inventors: Ruiyan Ge, Chapel Hill, NC (US); Li Wang, Chapel Hill, NC (US)

(21) Appl. No.: 17/870,307

(22) Filed: Jul. 21, 2022

Related U.S. Application Data
(60) Provisional application No. 63/224,631, filed on Jul. 22, 2021.

(51) Int. Cl. H01R 4/70; H01R 9/03; H02G 15/08

(52) U.S. Cl. CPC H01R 4/70; H01R 9/03; H02G 15/08

(57) ABSTRACT

A trunk bus connector for electrically coupling one or more branch cables to a trunk line. The trunk bus connector containing a junction area, overmold, undermold, and entry pathways arranged so that the branch cables can be coupled to the trunk line without the use of 90-degree bends. The entry of the branch cables relative to the trunk line being approximately 30 to 50 degrees resulting in easier, more reliable installation with less material required.

### FIELD OF THE INVENTION

The present disclosure is related generally to the collection of solar power and efficient transmission of captured solar generated electricity to one or more inverters for delivery to a power grid, energy storage device, and/or other electric consumer. More particularly, in some embodiments, the present disclosure relates to a trunk bus system that may enable better connection of one or more solar panels to an inverter or other electrical component.

### BACKGROUND

Solar panels have long been used to capture energy from the sun and convert the energy into electricity, specifically, direct current (DC) electricity. In many applications, it is desirable to collect the electricity from a panel or several panels and deliver the electricity to an energy storage device (e.g., battery) or other electrical component that may convert, store, or otherwise use the energy. In some embodiments, especially for example when the generated electricity is desired to be transmitted to an alternating current (AC) system (e.g., electric grid, household, etc.), it may be desirable to collect the power generated by the one or more solar panels and deliver the electricity to an inverter that converts the electricity from DC to AC, and passes the AC electricity onto the consumer (grid, household, etc.).

One conventional method of installing solar power DC wires is to connect a plurality of conducting (e.g., copper) photovoltaic extender wires from solar strings to a combiner box, and then combine several DC feeder lines from combiner boxes to an inverter. To implement this method, on-site technicians have to pull the wires, cut the wires to length, crimp connectors, and connect to the combiner boxes. This process is very labor intensive and time consuming, and the quality of work is very low and inconsistent. Additionally, existing wiring harnesses used to make the connections are labor intensive and yield failed and broken connections that often require re-work.

Further complicating matters, more recently, many solar module manufactures are launching high wattage power solar panels. Such panels have lower voltage at maximum power (Vmp) but higher short circuit current (Isc). Using existing wiring harnesses and methods, #6AWG copper PV wire, for example, will be required, substantially increasing costs and adding to the Capex value of solar installation. In addition, due to exposure to severe weather of most sites, combiner boxes installed on site malfunction often, requiring additional intensive maintenance. Furthermore, to better take advantage of the land, most sites try to go with higher numbers of trackers in a row. But solar sites are currently limited to 3 or 4 trackers due to DC loss requirements.

Previously, certain truck busses have been utilized that employ a parallel structure. Disadvantageously, in previous designs, the branch cable (smaller wire) must be bent at least twice—one˜90 degree bend to move the branch cable conductor down to the trunk cable (larger wire) and a second˜90 degree bend to align the branch cable with the trunk cable to facilitate electrical contact between the two. These multiple abrupt bends can lead to wire breaks, complicate installation, and add costs to installation, among other problems.

Accordingly, there is a need for a solution to solve the above issues, and to bring labor savings to the solar power installation.

### BRIEF SUMMARY OF THE INVENTION

The present disclosure includes a trunk bus device that, in some embodiments, may facilitate the electrical coupling between one or more branch cables from solar panels into a main trunk cable. More particularly, the present disclosure includes a device that may utilize an angle of approach of the branch cable to the trunk cable of approximately 30 to 50 degrees. In some embodiments, the electrical coupling of the branch line and trunk line may occur in a trunk bus comprised of a substantially rectangular shaped overmold and a substantially rectangular shaped undermold. This device may permit multiple branch lines to enter into a single trunk bus, and each branch line may be electrically coupled onto the main trunk line without requiring the use of undesirable 90-degree bends of the branch cables. In certain embodiments, multiple trunk busses may be used in tandem to permit the energy from numerous solar panels to be combined into a single main trunk line.

### BRIEF DESCRIPTION OF THE DRAWINGS

FIG. 1 illustrates a top view of the overmold of an example of the presently disclosed trunk bus device.

FIG. 2 illustrates a bottom view of the overmold of an example of the presently disclosed trunk bus device.

FIG. 3 illustrates a side view of the overmold of an example of the presently disclosed trunk bus device.

FIG. 4 illustrates an end view of the overmold of an example of the presently disclosed trunk bus device.

FIGS. 5A and 5B illustrate exemplary dimensions of the overmold of the presently disclosed trunk bus device shown in FIG. 1 and FIG. 3, though the presently disclosed truck bus device may be of any size/dimensions desired for any particular system or implementation.

FIG. 6 illustrates an exemplary instance of a branch line being coupled to a trunk line within the undermold located inside the presently disclosed trunk bus device.

FIGS. 7A-7F illustrate some exemplary arrangements of branch cables entering the undermold of the trunk bus to be coupled to a trunk line.

FIGS. 8A-8D illustrate the side, bottom, backside, and end view of the undermold portion of the presently disclosed trunk bus device according to one exemplary set of dimensions.

FIG. 9 provides an example of an exemplary location of the presently disclosed trunk device shown relative to the overall architecture of a solar farm.

FIG. 10 illustrates a more detailed example of how multiple trunk busses may be incorporated into the overall architecture of a solar farm, thereby allowing multiple panels to transfer power to the main trunk lines.

FIG. 11 illustrates an additional example of multiple trunk busses incorporated into the overall architecture of a solar farm, thereby allowing multiple panels to transfer power to the main trunk lines.

### DETAILED DESCRIPTION

The presently disclosed subject matter now will be described more fully hereinafter with reference to the accompanying Figures, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated Figures. Therefore, it is to be understood that the presently disclosed subject matter is not to be limited to the specific embodiments disclosed and that modifications and other embodiments are intended to be included within the scope of the appended claims.

In some embodiments, the present disclosure relates to a trunk bus solution that may be used to directly connect solar panels and inverters (or other receivers of solar generated electricity, or other electricity), without the need for combiner boxes and the associated combiner box maintenance and installation. By way of just one example, a trunk bus feeder/trunk may be made using 2kV aluminum photovoltaic wire and may range in sizes from 4/0 to 1000MCM, but larger or smaller sizes are also contemplated.

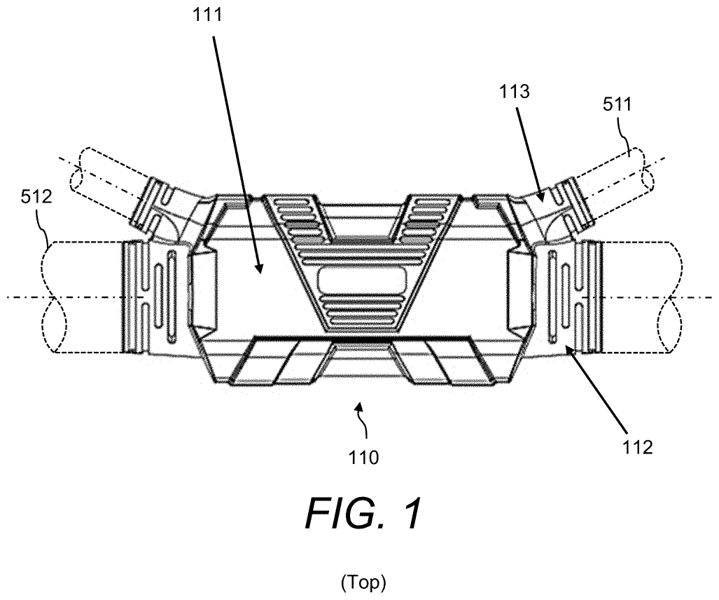

Referring now to FIG. 1, a top view of an exemplary trunk bus 110 is presented. In certain embodiments, the trunk bus 110 may include an undermold layer 210, an overmold layer 111, a trunk line through port 112 wherein one or more trunk lines 512 run through, and one or more branch line entry ports 113 wherein one or more branch lines 511 enter the trunk bus.

The branch lines 511 (smaller lines in the figures) may connect to solar panels, and the feeder/trunk cable 512 (e.g., the larger, central cable running through the joint) may be connected to an inverter or to a disconnect box or other electricity receiving device/component, which may, in some embodiments, include a switch and/or fuse protection. By using the trunk bus system, the usage of copper string wires, for example, may be minimized, and larger size aluminum wires (sizing according to NEC code requirements), which is more cost efficient then copper string wires, may also be utilized. Further, the need for combiner boxes and combiner boxes installation and maintenance can be eliminated. Since, in some embodiments, the main trunk/feeder size can be as large as 1000MCM, solar farms may exceed more than 4 or 5 high trackers while maintaining DC loss requirements.

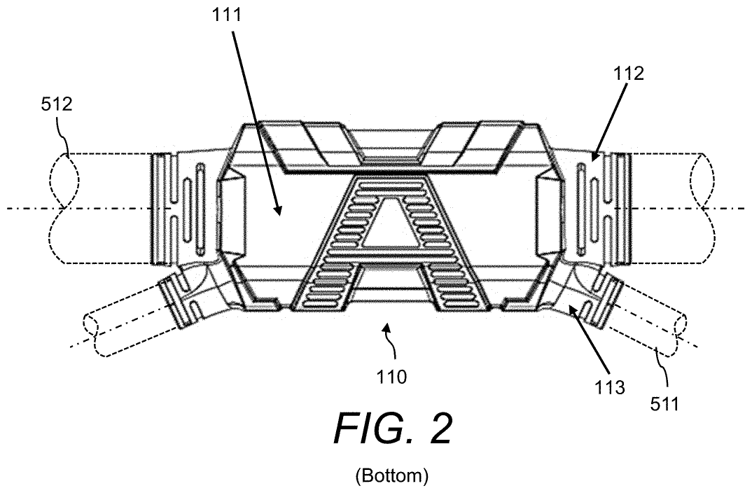

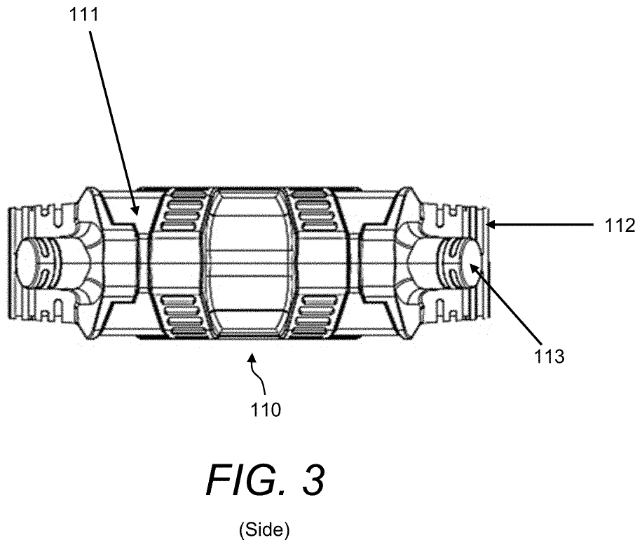

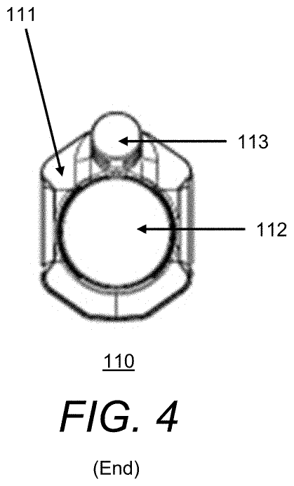

Referring now to FIGS. 2, 3, and 4, a bottom, side, and end view of an exemplary embodiment of the trunk bus 110 is presented respectively. Notably, each view includes an overmold layer 111, a trunk line through port 112 wherein one or more trunk lines 512 run through, and one or more branch line entry ports 113 wherein one or more branch lines 511 enter the trunk bus 110.

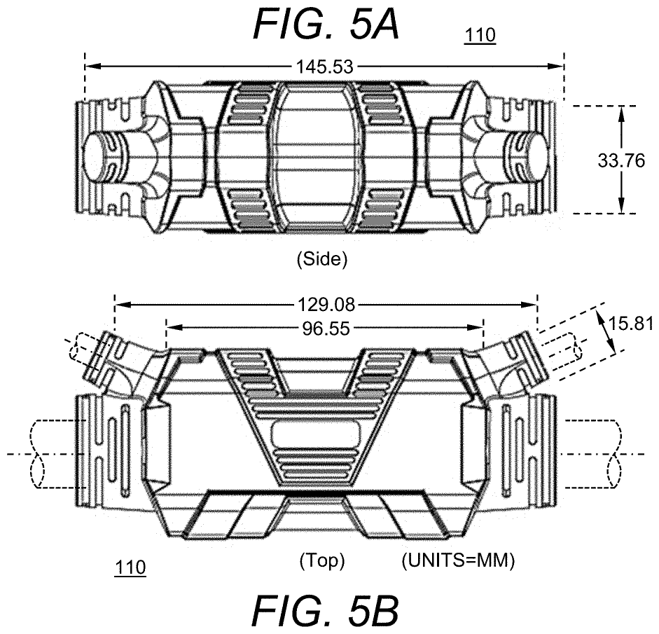

FIG. 5A and FIG. 5B both display exemplary dimensions of the overmold 111 of the presently disclosed trunk bus 110 device shown in FIG. 1-4.

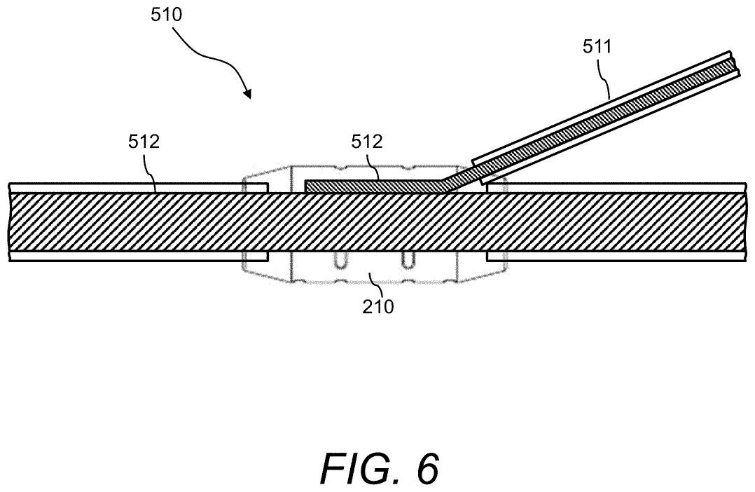

Those skilled in the art will appreciate that the presently disclosed invention eliminates several disadvantages with the parallel connectors commonly found in the prior art. As illustrated in FIG. 6, for example, the junction zone 510 within the trunk bus connector may provide for entry of the branch cable 511 at an angle, rather than parallel to the trunk cable 512, for example, approximately 45 degrees (though other angles are contemplated). One advantage is the elimination of multiple 90-degree bends necessitated by connectors of the prior art. Instead, the branch cable 511 requires only a single, substantially less than 90-degree bend, thereby eliminating stress on the branch cable 511, reducing the number of wire breaks during installation, and simplifying installation overall. The inclined or angled approach shown for example in FIG. 6 also allows for a greater bending radius of the branch cable 511 overall, which further protects the branch cable 511 and reduces installation issues and breaks. Additionally, the inclined or angled approach shown for example in FIG. 6 further allows for the branch cables 511 to be shorter, further reducing installation and material costs. Utilizing only a single bend, the branch cable 511 may approach and lay flat against the trunk cable 512 to be electrically coupled in the area within the undermold 210.

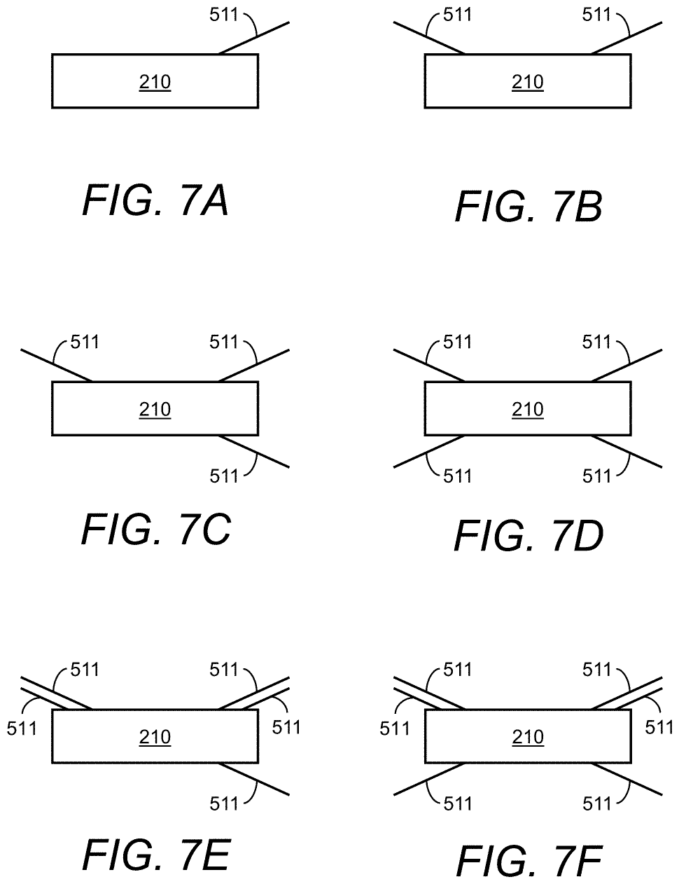

FIG. 7A-7F illustrate certain preferred examples of undermold 210 and branch line 511 arrangements. Modifications to the overmold 111 (not shown in FIG. 7A-F) and undermold 210 allow for the preferred, inclined installation approach taught by this disclosure. In certain embodiments, the undermold 210 may be manufactured with various dimensions so that multiple different size branch cables 511 may be accommodated, while still only necessitating a single bend in the branch cables 511. In certain other embodiments, the overmold may include multiple branch line entry ports so as to accommodate the coupling of one or more branch cables 511 to a single trunk line 512, thereby resulting in reduced cost, increased efficiency, and easier installation and maintenance of the trunk bus system when utilized in solar electricity generation arrays. It should be noted that there are numerous examples of the number and arrangement of trunk lines 511 that may enter the undermold 210 depending on the specific need within the electricity generation array, some of which may not be present in FIG. 7A-7F but are nonetheless inherently present in the design and this disclosure.

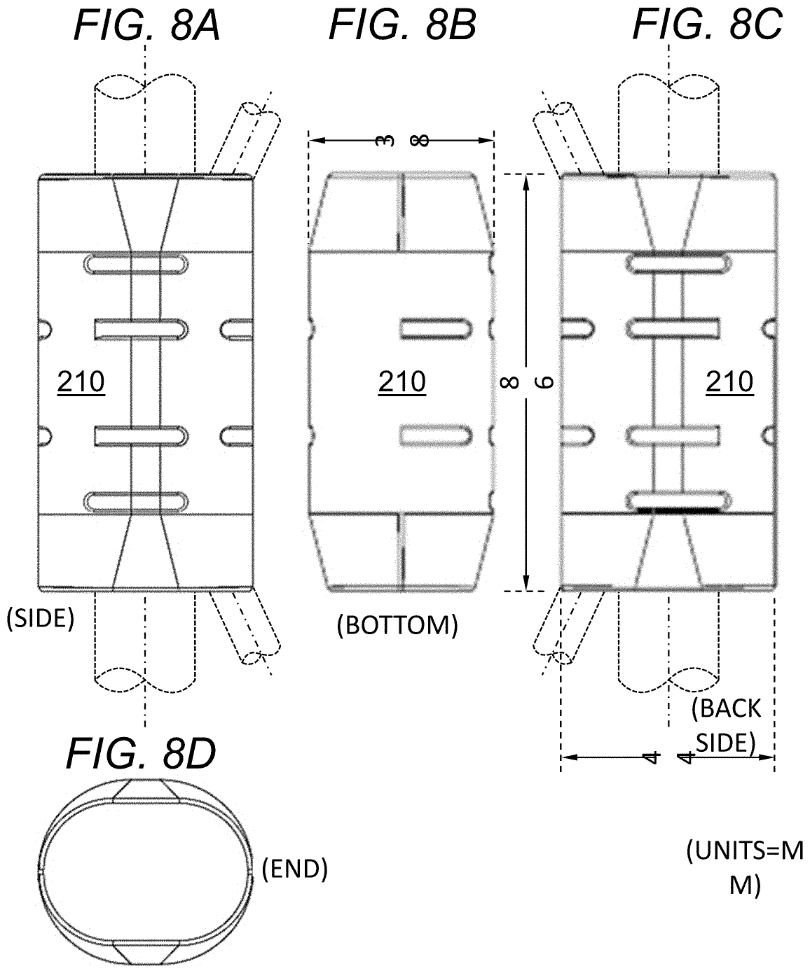

Referring now to FIG. 8A-8D, side, bottom, backside, and end views of the undermold 210 with exemplary dimensions are presented. It should be noted that other examples of the undermold 210 may also be contemplated to accommodate the potential arrangements of branch cables 511 displayed and contemplated in FIG. 7A-7F.

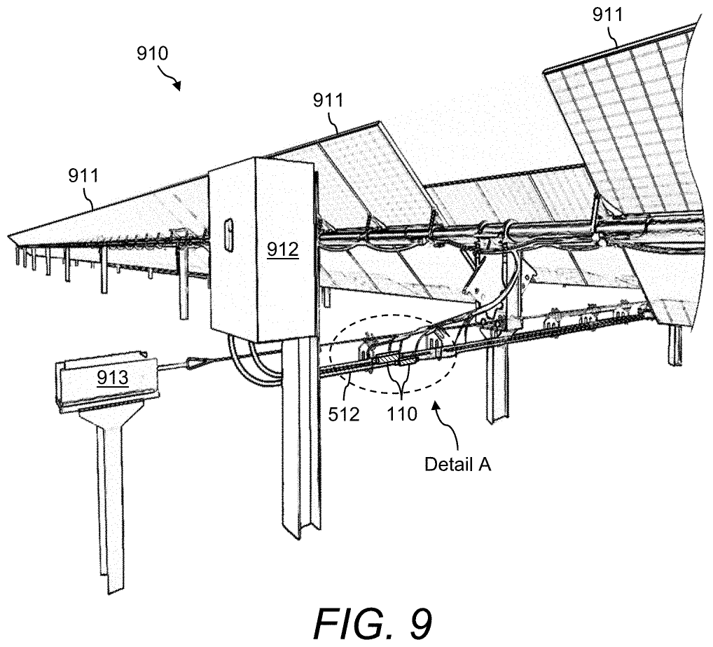

FIG. 9 presents an exemplary location of the presently disclosed trunk bus devices 110 shown relative to the overall architecture of a solar farm 910 or electricity generation array as they might be installed and used in the field. Those skilled in the art will appreciate that an exemplary trunk bus device 110 is illustrated with multiple branch cables 511 extending to multiple solar panels 911. Advantageously, the inclined branch cable installation enables ease of installation, and better protects the branch cables by allowing for fewer bends of the conductor metal in the connector, and increase bend radius of the branch cable, among other things. Also present in FIG. 9 is an electrical disconnect box 912 and an inverter 913, both of which are commonly found electrical components necessary for solar array operation.

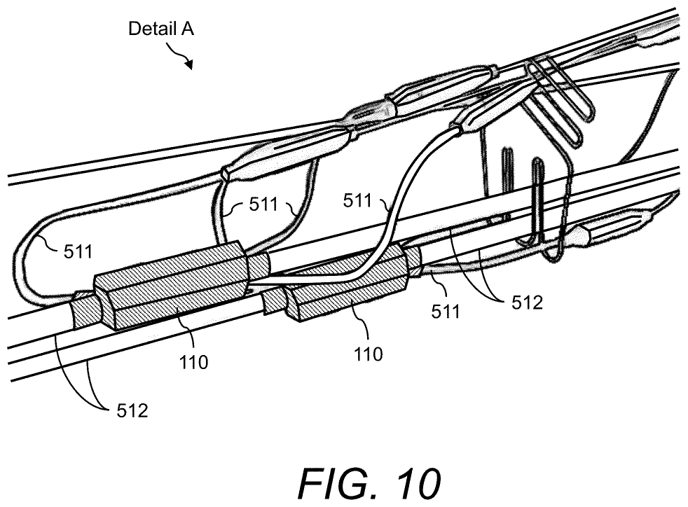

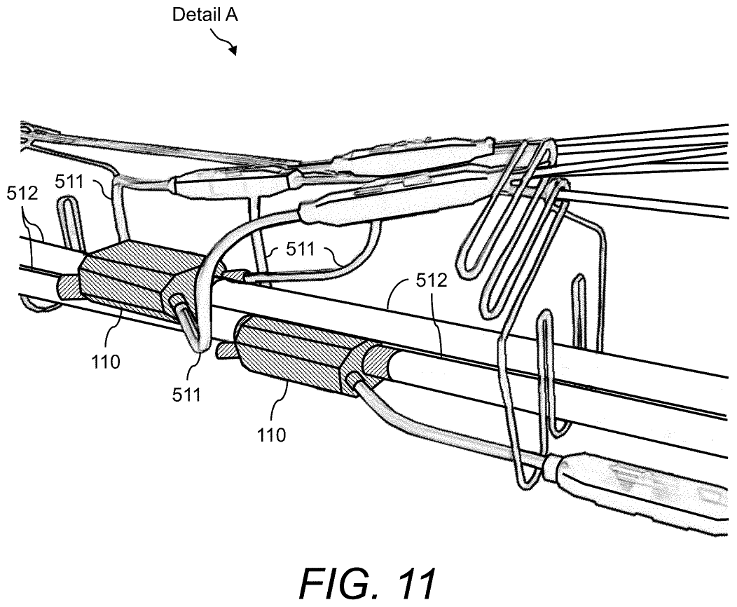

FIGS. 10 and 11 illustrate closer views of the portion of FIG. 9 designated as Detail A. This portion is of particular interest because it illustrates an exemplary instance of how the presently disclosed trunk bus device 110 may be arranged for use in a solar array. Particular attention should be directed at how numerous branch lines 511 may feed into the trunk bus device 110, and that multiple trunk bus devices 110 may be located on a trunk line 512. This broader implementation of the presently disclosed trunk bus devices 110 allows the electrical current produced by multiple solar panels to be consolidated into a single trunk line 512 before being transferred for further processing.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

Throughout this specification and the claims, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments, ±100% in some embodiments +50%, in some embodiments ±20%, in some embodiments +10%, in some embodiments ±5%, in some embodiments +1%, in some embodiments ±0.5%, and in some embodiments +0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

Although the foregoing subject matter has been described in some detail by way of illustration and example for purposes of clarity of understanding, it will be understood by those skilled in the art that certain changes and modifications can be practiced within the scope of the appended claims.

What is claimed is:

1. A trunk bus connector for electrically coupling one or more branch cables to a trunk line, the connector comprising:
a junction area where stripped portions of the one or more branch cables can lay flat against a striped portion of the trunk line to electrically couple the branch cables to the trunk line;
an overmold substantially encapsulating the junction area, the overmold comprising one or more branch entry pathways disposed proximate one or more corners of the overmold forming one or more trunk line entry pathways;
wherein the one or more branch entry pathways are angled so that the branch cable enters into the junction area to be coupled with the trunk line such that only a single bend in the branch cable is required inside the connector; and
an undermold for securing the stripped portions of the trunk cable and branch cables and branch cables together.

2. The trunk bus connector of claim 1 wherein the angle at which the branch cable approaches the trunk line is between approximately 30 and 50 degrees.

3. The trunk bus connector of claim 2 wherein the angle at which the branch cable approaches the trunk line is approximately 45 degrees.

4. The trunk bus connector of claim 1 wherein the branch entry pathways are angled at approximately 30 to 50 degrees relative to the trunk line entry pathways.

5. The trunk bus connector of claim 4, wherein the branch entry pathways are angled at approximately 45 degrees relative to the trunk line entry pathways.

6. The trunk bus connector of claim 1, wherein the trunk line entry pathways have a larger diameter than the branch entry pathways so that the trunk line entry pathways may accept a larger diameter line.

7. The trunk bus connector of claim 1, wherein a plurality of trunk bus connectors may be placed in tandem along a single trunk line.

8. The trunk bus connector of claim 1 comprising two branch entry pathways.

9. The truck bus connector of claim 1 comprising three branch entry pathways.

10. The trunk bus connector of claim 1 comprising four branch entry pathways.

11. A method of coupling one or more branch cables to a trunk line, the method comprising:
a. stripping the trunk line to reveal a junction portion of the trunk line;
b. stripping ends of the one or more branch cables to be coupled to the trunk line;
c. providing a connector comprising a junction area where the stripped portions of the one or more branch cables can lay flat against the junction portion of the trunk line to electrically couple the branch cables to the trunk line, and an overmold substantially encapsulating the junction area, the overmold comprising one or more branch entry pathways disposed proximate one or more corners of the overmold forming one or more trunk line entry pathways, wherein the one or more branch entry pathways are angled so that each of the branch cables enter into the junction area to be coupled with the trunk line such that only a single bend in the branch cable is required inside the connector; and an undermold for securing the stripped portions of the trunk cable and branch cables and branch cables together;
d. inserting the one or more stripped branch cable ends into the connector; and
e. securing the connector to couple the branch cables to the trunk line.

12. The method of claim 11 wherein the angle at which the branch cable approaches the trunk line is between approximately 30 and 50 degrees.

13. The method of claim 12 wherein the angle at which the branch cable approaches the trunk line is approximately 45 degrees.

14. The method of claim 11 wherein the branch entry pathways are angled at approximately 30 to 50 degrees relative to the trunk line entry pathways.

15. The method of claim 14 wherein the branch entry pathways are angled at approximately 45 degrees relative to the trunk line entry pathways.

16. The method of claim 11 wherein the trunk line entry pathways have a larger diameter than the branch entry pathways so that the trunk line entry pathways may accept a larger diameter line.

17. The method of claim 11 wherein a plurality of trunk bus connectors may be placed in tandem along a single trunk line.

18. The method of claim 11 wherein the connector comprises one branch entry pathway.

19. The method of claim 11 wherein the connector comprises two branch entry pathways.

20. The method of claim 11 wherein the connector comprises four branch entry pathways.
